(19) United States
(12) Patent Application Publication
(10) Pub. No.: US 2018/0235160 A1
(43) Pub. Date: Aug. 23, 2018

(54) System and Method to Deter and Repel Deer or Other Animals from Rubbing on Trees or Eating Foliage

(71) Applicant: Wayne Krouse, Mountain Brook, AL (US)

(72) Inventor: Wayne Krouse, Mountain Brook, AL (US)

(21) Appl. No.: 15/892,783

(22) Filed: Feb. 9, 2018

Related U.S. Application Data
(60) Provisional application No. 62/462,402, filed on Feb. 23, 2017.

(51) Int. Cl. A01G 13/10; A01M 29/00

(52) U.S. Cl. CPC A01G 13/10; A01M 29/00

(57) ABSTRACT

A system to deter and repel deer or other animals from rubbing on trees or eating foliage using a modified bubble pack having first and second layers of plastic film attached together and defining a multiplicity of spaced apart, primary chambers therebetween, and an optional third layer defining a multiplicity of spaced apart secondary chambers aligned generally adjacent the primary chambers, with animal repellent within the primary chamber, and propellant within the secondary chamber that upon activation of the propellant causes the animal repellent to be expelled outward. The repellent may be liquid, gas or powder, and may be mixed with propellant in a primary chamber. In another embodiment, repellent For filingis exposed by chamber puncture. An adhesive backing may be applied to sheets of bubble pack that are rolled or cut into sheets.

### CROSS REFERENCE TO RELATED APPLICATIONS

This application takes priority from a provisional application for patent bearing Ser. No. 62/462,402 filed Feb. 23, 2017 entitled “System and Method to Deter and Repel Deer or Other Animals from Rubbing on Trees or Eating Foliage” and is incorporated as if fully set forth herein.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of animal repellent, and more specifically to system and method to deter and repel deer or other animals from rubbing on trees or eating foliage.

### BRIEF SUMMARY OF THE INVENTION

The primary advantage of the invention is to provide a system for disseminating animal repellent.

Another advantage is that it is a water proof delivery system so that prevents being washed away or diluted when it rains or when water from irrigation sprinklers contacts the repellent.

Another advantage of the invention is to provide a bubble system for storing and distributing deer or other animal repellent in the field.

Yet another advantage of the invention is to provide a method for manufacturing a delivery system of animal repellent.

Yet another advantage is to provide a deer or animal repellent that may be affixed to different parts of foliage (trunks and leaves).

Additional objects, features and advantages of the present invention will become more readily apparent from the following detailed description of preferred embodiments when taken in conjunction with the drawings wherein like reference numerals refer to corresponding parts in the several views.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a cross sectional enlarged view of a cellular material which contains entrapped bubbles of air or other gases or liquids sometimes generically referred to as bubble pack for a dispersal system according to a preferred embodiment of the invention.

FIG. 2 is a perspective view of a sheet of a bubble pack dispersal system according to a preferred embodiment of the invention.

FIG. 3 is a perspective view of a roll of bubble pack dispersal system according to a preferred embodiment of the invention.

FIG. 4 is side view of a bubble pack dispersal system according to a preferred embodiment of the invention.

FIG. 5 is a cross sectional view of an alternative embodiment of a bubble pack dispersal system according to a preferred embodiment of the invention.

FIG. 6 is a perspective view of a leaf adhered with a bubble pack dispersal system according to a preferred embodiment of the invention.

FIG. 7 is a side schematic view of a machine for making unfilled bubble pack to be later filled with repellent according to a preferred embodiment of the invention.

FIG. 8 is a side schematic view of a bubble pack delivery system according to a preferred embodiment of the invention.

FIGS. 9a and 9b are a side view of an alternative means of packaging filled bubble pack sections according to a preferred embodiment of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for later filed claims and as a representative basis for teaching one skilled in the art to employ the present invention in virtually any appropriately detailed system, structure or manner.

When deer and other animals are rutting (marking territory with their scent glands) they will typically rub their antlers on young trees whose trunk diameters are less than the width of their antlers. Sometimes deer rub the outside of their antlers on trees wider than the width of their antlers. Deer prefer and will select very young trees with trunk diameters that are much smaller than the width spacing of their antlers. Other antlered animals have similar behavior as do animals with claws, such as squirrels, voles, rabbits, and porcupines, to name few.

When rubbing the trees the deer will strip some or most of the outer bark of the young tree and in many cases will strip into the cambium and phloem layers. When this happens, the tree can be permanently damaged, resulting in retarded growth rate due to reduced supply of nutrients or in some cases tree death. Additionally, deer and other animals will feed on the leaves of trees, shrubs or other plants causing significant damage to landscaping.

It is also known that some compounds can deter deer although delivery of those compounds directly to deer receptors of all types has always been challenging.

Therefore, disclosed herein is a new and improved system for the dispersal of deer or other animal repellent to protect trees, shrubs and landscaping and dissuade deer and other animals from eating foliage.

Turning now to FIG. 1, there is shown a cross sectional view of a modified bubble pack dispersal system in accordance with a preferred embodiment of the invention. A three layer bubble pack system is formed with existing bubble pack machines modified for liquid or gaseous filled bubbles. A first layer 12 and second layer 18 of typically plastic film are attached or laminated together to define primary chamber 10 therebetween. A third layer 14 is attached or laminated under first and second layers 12 and 18 to form a secondary chamber 16 typically disposed just below primary chamber 10. Secondary chamber 16 has a propellant 15 between third layer or backer layer 14 and middle or second layer 18. Above second layer 18 is primary chamber 10 formed between second layer 18 and upper layer 12 that contains a deer deterrent material 13.

Although shown in an enlarged view, the layers 12, 14 and 18 are attached together by heat fusing, or with a sealant or other adhesive binder to create chambers 10 and 16 as further described herein.

Alternatively, the advantages of this invention could be accomplished with a two layer bubble pack material having a plurality of chambers created as herein described and claimed. A two ply or two layer system would preferably have repellent within a single bubble of a multi-bubble system that upon rupture would expel. It may also have combined within the bubble an additional propellant for further dissemination of the repellent.

When the deer or other animal presses its antlers, nose, or claws against primary chamber 10 and pops the bubble formed by chamber 10, deterrent 13 is sprayed outward by secondary chamber 16, either by the deer further puncturing secondary chamber 16, or by action of the pressure created by propellant 15 that is released when primary chamber 10 is punctured.

Upon activation of the pack, the chamber explodes preferably with the aid of propellant, which may be an oxidizer, and the deer repellent is dispersed onto the deer. This causes the deer to flee and avoid the plant life or other items the user wishes to protect.

Chamber or bubble size may be any of a variety from as small in the approximate range of ½ millimeter or smaller to larger diameters up to several inches. Depending on the usage, a sheet of bubble pack could also have a variety of different sized bubbles on a single sheet.

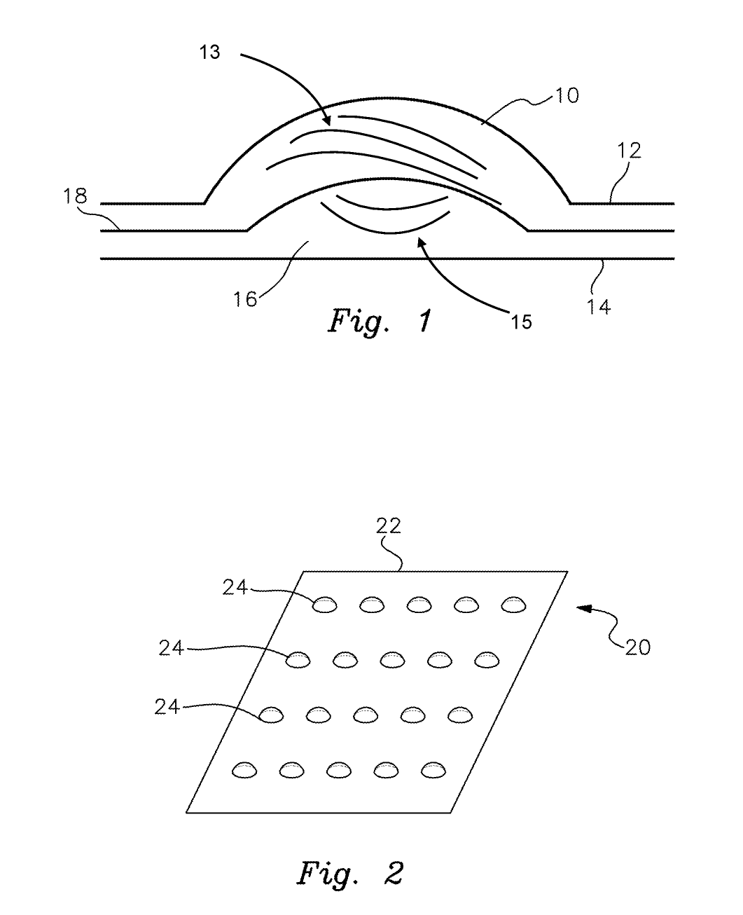

FIG. 2 shows a sheet of bubble pack 20, having a plurality of bubbles 24 on a sheet 22 that may be placed around a tree trunk, post or other supporting structure which may be engaged by a deer or other animal. As previously described each bubble 24 may be comprised of two chambers one below the other for placement of repellent and propellant for dispersal upon contact by an animal. It is also possible to have a single chamber bubble that just contains liquids, gas or powder deterrent.

In an alternative embodiment, the deer repellent and propellant may be contained within a single bubble together that upon puncture causes the repellent to spray outward. In this embodiment, bubbles 24 would be a single chamber having the appropriate material. Further, in some cases, the single bubble may contain only deer repellent that is dispersed through the direct action of the deer or other animal causing it to attach to the animal without the aid of a propellant. Even without the lower chamber of repellent, the bubble pack may contain liquid or gaseous deer repellent that upon deer rubbing is broken and dispersed.

In a preferred embodiment, a tree trunk pack having a special type of bubble pack that has a two-part bubble system as described above can project the deer deterrent onto a deer when the bubble is broken by the rubbing of the deer antlers. The rubbing action of the deer is typically vigorous and adequate to break the layers of the bubble pack. The material may be bio-degradable plastic bubble pack material since some people will allow the leaves that drop in the fall on the ground. This may be also accomplished with a two-ply system of bubble pack with each chamber filled with the desired repellent material.

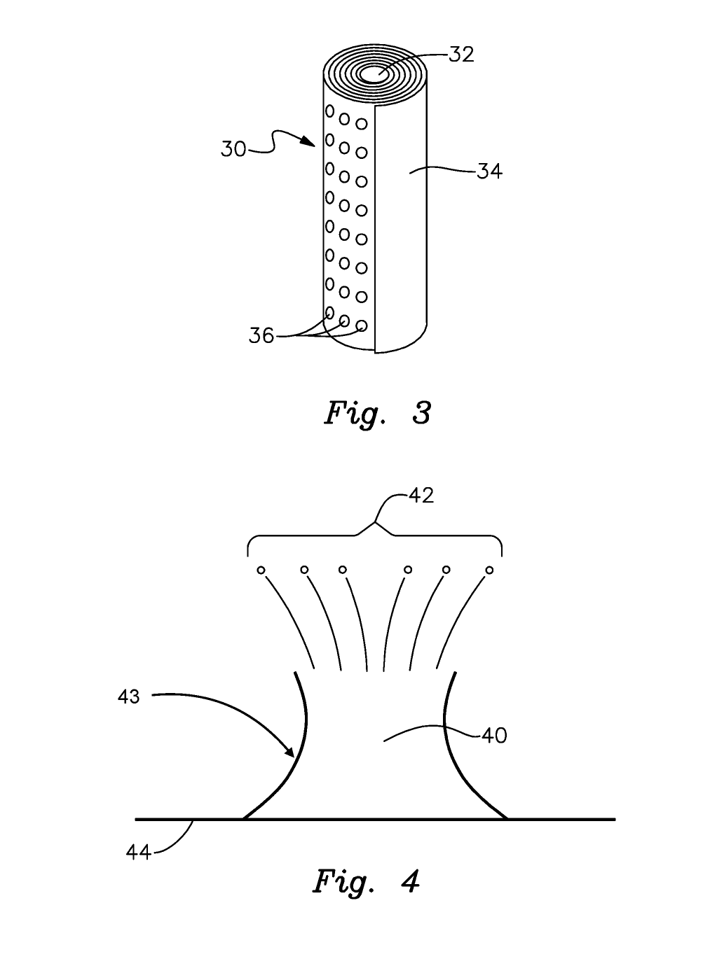

FIG. 3 shows deer repellent bubble pack 30 with a plurality of bubbles 36 disposed about roll 34 having cardboard tube 32 for easy distribution and handling and mounting on a axle for ease of use. Using modified bubble pack machines, the present invention may be manufactured and then rolled into transportable units. A modified bubble pack system is disclosed further herein for this purpose.

FIG. 4 shows a single bubble 40 attached to backer 44 that upon puncture by a deer explodes and disperses deer repellent 42 outward according to a preferred embodiment of the invention. In this embodiment, the deer repellent is contained in a bubble with or without propellant that may enhance dispersal of the deer repellent. The bubble is formed with a laminated first layer 43 that is formed on backer layer 44. As previously noted, off the shelf bubble pack material may be used and filled with liquids, solid powders or gas to deter the deer or other animals. In this embodiment, there may be no propellant if desired.

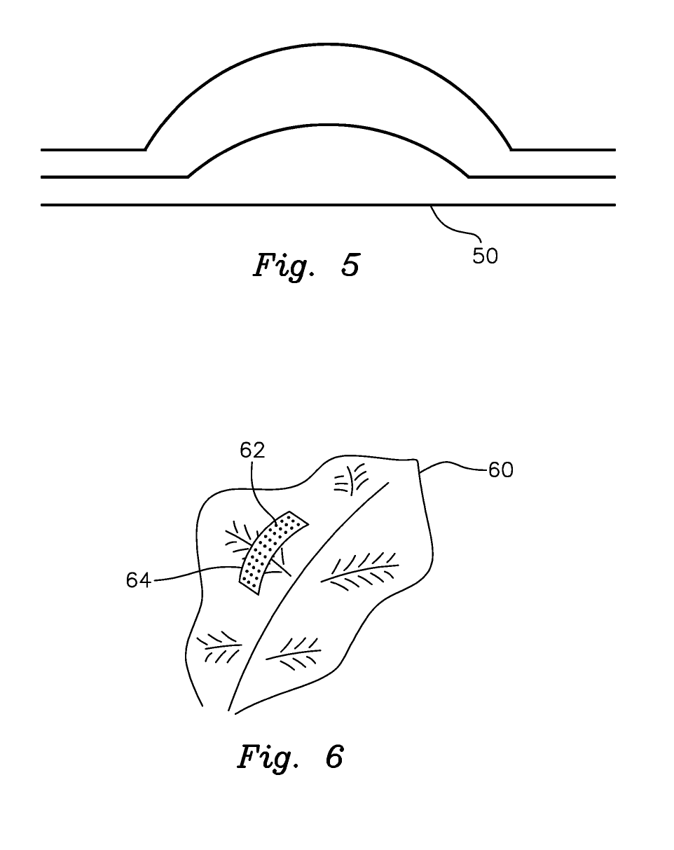

FIG. 5, shows an alternative embodiment where the lower sheet or section of a sheet is covered with adhesive 50 on the backing side of the pack. The adhesive backing allows the pack to be placed on planar or curved substrates, including leaves, walls, posts or other supporting structures. Again, a deer or other animal may come into contact with the pack, breaking the bubble and thereby exposing the repellent. Miniature or smaller versions of the bubble pack as described can be “attached” to plant leaves or their underside with the adhesive backer to prevent foliage eating by the deer.

FIG. 6 shows an adhesive backed bubble pack 64 with relatively small bubbles 62 on the upper surface attached to foliage 60 according to a preferred embodiment of the invention. In this embodiment, bubbles may be quite small but are formed with laminated plastic as previously described. In another embodiment, the repellent and propellant if needed could be adhered similar to fragrance pull-apart samplers with microcapsules that upon eating or disturbing of the leaves will impart repellent and deter the animal. Microcapsules may also be employed in other embodiments using a packed form as previously described. This may be also accomplished with a two ply system of bubble pack with each chamber filled with the desired repellent material.

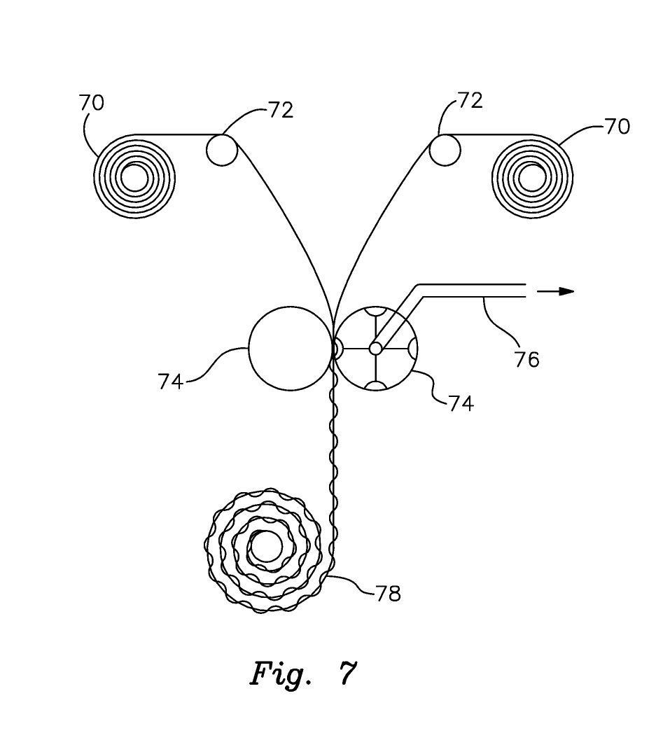

FIG. 7 shows a machine for making unfilled bubble pack to be later filled with repellent as is described bellow in FIG. 8. In FIG. 7 the plastic feed rollers 70 supply sheets of plastic that move along rollers 72. The plastic is then pressed between heated bubble chamber suction rollers 74. The heated bubble chamber suction rollers 74 are equipped with an air suction tube 76, which alternately suck air out of the bubble pack, creating pockets on opposite sides in alternating fashion. The unfilled bubble pack 78 is then ready to be filled with repellent, as described in FIG. 8. Systems for creation of bubble pack are generally known in the art and are disclosed in for example, U.S. Pat. Nos. 6,410,119 and 6,761,960 to De Luca et al.

FIG. 8 shows an unfilled bubble pack delivery system where the unfilled bubble pack 80 is moved along roller 90. An air injector tank 82 injects air injector 86 into the bubble to keep the chamber open during filling, while repellent supply tank 84 injects repellent via repellent injector 88 into the open chamber of the bubble pack. The repellent in repellent supply tank 84 can be either liquid, powder, or gas. As the bubble pack moves down to pass between actuating heated sealers 92, which seal the repellent in the now filled bubble pack. Actuating heated sealers 92 are powered by cables, such as cable 94. The adhesive supply tank 96 supplies adhesive to spray nozzle 98, which sprays the adhesive onto the bubble pack as it passes. Adhesive backing 100 is then applied via roller 102 as the bubble pack is packaged into a rolled tube for delivery.

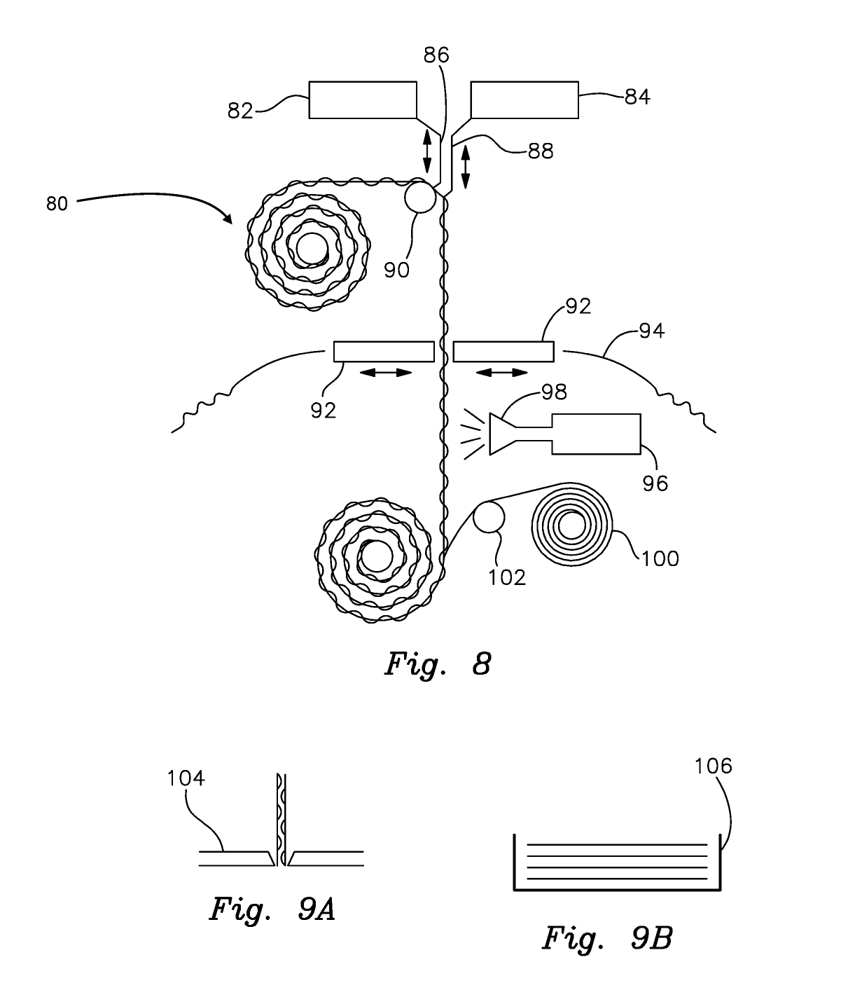

FIGS. 9a and 9b shows an alternative means of packaging filled bubble pack, wherein, after the adhesive backing 100 had been applied via roller 102, the bubble pack then passes through sheet cutting implements 104, which cuts the bubble pack into sheets that are then stacked and packaged in product sheet bins 106. Uncut sheets can be produced in rolls.

The method and system of the current invention may be employed in conjunction with any of a variety of manufacturing methods and plastic packs available, including wherein the repellent is contained in rectangular strips or contiguous bubbles. Further, the method and system may be integrated into other mechanisms for adherence including the use of hoop and loop fasteners, string, bungee cords and the like.

Although described with reference to preferred embodiments of the invention, it should be readily understood that various changes and/or modifications can be made to the invention without departing from the spirit thereof. In general, the invention is only intended to be limited by the scope of the later issued claims.

I claim:

1. A system to deter and repel deer or other animals from rubbing on trees or eating foliage comprising:
a. first and second layers of plastic film attached together and defining a multiplicity of spaced apart, primary chambers therebetween;
b. a third layer of plastic film attached to the second layer and defining a multiplicity of spaced apart secondary chambers aligned generally below each of the primary chambers;
c. animal repellent disposed within the primary chamber; and
d. propellant disposed within the secondary chamber that upon activation of the propellant causes the animal repellent to be expelled outward from the primary chamber.

2. The system to deter and repel deer or other animals from rubbing on trees or eating foliage as claimed in claim 1 wherein the animal repellent is a liquid, powder or gas.

3. The system to deter and repel deer or other animals from rubbing on trees or eating foliage as claimed in claim 1 wherein the repellent and propellant are maintained in their respective chambers under pressure.

4. The system to deter and repel deer or other animals from rubbing on trees or eating foliage as claimed in claim 1 further comprising an adhesive backing on the third layer.

5. The system to deter and repel deer or other animals from rubbing on trees or eating foliage as claimed in claim 1 wherein the secondary chamber is breakable by an animal to activate the propellant.

6. The system to deter and repel deer or other animals from rubbing on trees or eating foliage as claimed in claim 1 wherein the propellant is maintained in the secondary chamber under relative pressure that upon puncturing of the primary chamber causes the secondary chamber to break and expel the propellant.

7. A system to deter and repel deer or other animals from rubbing on trees or eating foliage comprising:
a. first and second layers of plastic film attached together and defining a multiplicity of spaced apart, chambers therebetween;
b. animal repellent disposed within at least one of the chambers; and
c. propellant disposed within the at least one chamber that upon puncture of the chamber causes the propellant to expel the animal repellent outward from the chamber.

8. A system to deter and repel deer or other animals from rubbing on trees or eating foliage as claimed in claim 7 comprising an adhesive backing to the second layer.

9. A system to deter and repel deer or other animals from rubbing on trees or eating foliage as claimed in claim 7 wherein the chambers are less than an inch in diameter.

10. A system to deter and repel deer or other animals from rubbing on trees or eating foliage as claimed in claim 7 wherein the laminated layers are formed in a continuous sheet for placement on rolls.

11. A system to deter and repel deer or other animals from rubbing on trees or eating foliage as claimed in claim 7 wherein the laminated layers are cut into rectangular sheets.

12. A system to deter and repel deer or other animals from rubbing on trees or eating foliage as claimed in claim 7 further comprising chambers that are under pressure.

13. A system to deter and repel deer or other animals from rubbing on trees or eating foliage comprising:
a. first and second layers of plastic film attached together and defining a multiplicity of spaced apart, chambers therebetween;
b. animal repellent disposed within at least one of the chambers; and
c. upon puncture of the chamber repellent is exposed to the animal from the chamber.

14. A system to deter and repel deer or other animals from rubbing on trees or eating foliage as claimed in claim 13 further comprising propellant in the at least one chamber with the repellent.

15. A system to deter and repel deer or other animals from rubbing on trees or eating foliage as claimed in claim 13 further comprising a third layer of plastic film laminated to the second layer and defining a multiplicity of spaced apart secondary chambers aligned generally below each of the primary chambers.

16. A system to deter and repel deer or other animals from rubbing on trees or eating foliage as claimed in claim 13 further comprising an adhesive backing applied to the second layer.

17. A system to deter and repel deer or other animals from rubbing on trees or eating foliage as claimed in claim 13 further comprising a third layer with an adhesive backing.

18. A system to deter and repel deer or other animals from rubbing on trees or eating foliage as claimed in claim 15 wherein the secondary chambers are filled with propellant.
